(19) United States
(12) Patent Application Publication
(10) Pub. No.: US 2008/0133312 A1
(43) Pub. Date: Jun. 5, 2008

(54) Automated Systems for Aggregating, Identifying, and Analyzing Real Estate Wealth

(76) Inventor: Jennifer Howell Marston, Atlantic Highlands, NJ (US)

Correspondence Address: Jennifer Marston, 431 Ocean Blvd, Atlantic Highlands, NJ, 07716, US

(21) Appl. No.: 11/566,304

(22) Filed: Dec. 4, 2006

(51) Int. Cl. G06F 17/30

(52) U.S. Cl. 705/10

(57) ABSTRACT

The invention is business intelligence system and method for multi-faceted aggregation and analysis of property ownership which enables the identification and classification of individuals and corporate entities for use in generating product and service marketing lists/groups. The inventions application provides its users with a knowledge base about clients and potential clients and allows users to customize their output by applying their own analytics to the inventions base results. The system can provide input to automated marketing systems or interactive decision support systems that support the real estate, mortgage, accounting, or legal or other professions.

### BACKGROUND

Whereas other real estate analysis systems base their usefulness on providing real estate holding information about a specific entity and/or its corporate competition, the focus of the invention is a method which produces categorized groups/lists of real estate holders. Based upon their selected criteria, the user of the invention benefits by having an aggregated list view of who owns what real estate. And further using the characteristics/criteria that define group(s) generated by the invention, the user of the invention can determine which—if not all—of the real estate holders in the group(s) are prospective customers for their market. Therefore, the usefulness of the invention is to professionals who will benefit from identifying a client base through the characteristics of their real estate holdings; the invention can be used to identify a client base and to add new prospects to an existing client/marketing base. Other values of the invention include the ability of the user to customize the aggregations based upon their own criteria, and apply selection layers to the outputted groups, to further codify and customize the results, and to add or change codification criteria. The system also allows its users to eliminate errors in the aggregations if the public data is flawed.

A simple example of how the invention works follows:

Case background: A Real Estate practitioner, accountant or other professional sends out multiple advertisement cards to their flat geographic real estate farm. Generally, this is costly and they receive dismal results. Additionally, often respondents are not in the category of those ready or poised to do business.

Invention response: By using the invention, they are able to intelligently identify those in their market more likely to produce business. In this example the user may choose to generate a list that shows persons/entities in a geographic area that own 5 (2-5, >60, etc.) or more properties. They might further choose to classify these persons/entities by type of properties, value, time held, etc. They can also use the system to apply heurists or their own analytic criteria. For example the system might show all those who own 5 or more properties and are classified as buyers because they have acquired new property within a system or user defined period of time. To a legal, accountant, mortgage, real-estate, or other professional this knowledge of whom to market to (who to know) is invaluable. A client that has 20 places to sell, mortgage or exchange is more valuable than a client that only has one.

These results can be put through the marketing systems as generated, or the user can apply their own analytics to eliminate, or add to their personal clientele catalog.

What is claimed is:

1. A method for identifying and presenting potential clientele through a series of aggregations and user driven analysis of real property ownership. Comprising of the following steps:
1. Raw public domain data is imported into staging structures in a relational database management system
2. A series of aggregations of on said data are performed. Example aggregations (“roll ups”) include:
a. Count of distinct persons/entities and the number of properties they own limited by, geography, assessed valuation, sale, sale date, and other system and user driven criteria as supported by the data
b. Count of distinct owner addresses and the number of properties associated with their ownership, limited by geography, assessed valuation, zoning, sale date, and other system and user driven criteria as supported by the data
c. Count of a particular property zoning type limited by size, sales data, geography, and other system and user driven criteria
3. Production of result lists showing “rolled up” property ownership. For example: a list of all the people/entities that own more than seven (N) properties in a geographic area
4. Production of a detailed list showing all the real estate holdings and their attributes of those in the lists generated in step 3 above.

2. An application for presenting the raw data and generated list/group output to the user on a computer screen and to allow the user to drill down own individual records and manipulate the output through further analysis.

3. A time based analysis of property and money flow consisting of further classification and aggregation of potential clientele as buyers, sellers or holders of real estate based upon the applications defaults or user entered criteria, for example the user can specify that real estate holders who have sold 5 properties over the period of 2 years be classified as sellers.

4. An software interface for analysis and symbolic hierarchal naming of persons or entities that are identified as being one and the same, but whose public domain information prevents and accurate aggregation without said symbolic naming, for example a symbolic name can be applied where the following naming inconsistency is known to the user of the invention: “River enterprises” is the same real estate holder as “Jennifer H. River”.

5. A method for outputting the aggregations in the form of electronic and paper lists that can be fed to an automated marketing system.

6. Generation and storage of list catalogs that can be retrieved from the database for future use/reference.

7. An automated marketing system that takes generated lists and output personalized recipient and sender information, including stored graphics.

8. Logging of marketing materials to individuals/entities in user defined catalogs.
